(19) United States
(12) Patent Application Publication
(10) Pub. No.: US 2026/0338166 A1
(43) Pub. Date: Oct. 29, 2026

(54) FLOATING SUPPORT STRUCTURE WITH MULTIPLE CENTRAL COLUMNS FOR OFFSHORE WIND TURBINE AND METHOD FOR ASSEMBLING SUCH A STRUCTURE

(71) Applicant: SAIPEM S.A., Montigny le Bretonneux (FR)

(72) Inventors: Eric KERDILES, Montigny le Bretonneux (FR); Christophe COLMARD, Montigny le Bretonneux (FR); Andrea MANCA, Montigny le Bretonneux (FR); Hugues GONZALEZ, Montigny le Bretonneux (FR)

(21) Appl. No.: 19/110,907

(22) PCT Filed: Sep. 13, 2023
(86) PCT No.: PCT/FR2023/051396

§ 371 Date: Mar. 12, 2025

(30) Foreign Application Priority Data
Sep. 21, 2022 (FR) FR2209538

(51) Int. Cl. F03D 13/25; B63B 27/12; B63B 35/44; B63B 39/03; B63B 75/00; B66C 23/18; B66C 23/52; F03D 13/10; F03D 13/20

(52) U.S. Cl. CPC F03D 13/256; B63B 27/12; B63B 35/44; B63B 39/03; B63B 75/00; B66C 23/185; B66C 23/52; F03D 13/112; F03D 13/2005; B63B 2035/446; F05B 2240/93; F05B 2240/95

(57) ABSTRACT

A floating support structure for an offshore wind turbine includes a lower connector centered on the axis of the wind turbine mast, featuring at least three lower receptacles evenly distributed around the mast's axis. It also includes an upper connector centered on the mast's axis, which comprises reception means for the wind turbine mast in its upper part and at least three upper receptacles evenly distributed around the mast's axis in its lower part. Additionally, there are at least three identical tubular central columns, each assembled at their lower ends in one of the receptacles of the lower connector and at their upper opposite ends in one of the receptacles of the upper connector, forming a floating support pylon that aligns vertically with the wind turbine mast.

### TECHNICAL FIELD

The present invention relates to the general field of offshore wind turbines that are implanted off coast, and more particularly to floating support structures for floating offshore wind turbines.

The invention also relates to a process for installation of an offshore wind turbine fitted with such a support structure.

### PRIOR ART

The aim of an offshore wind turbine is to make use of wind energy to produce electricity by means of a turbine and an electric generator. There are two main types of offshore wind turbines: fixed wind turbines which are implanted on the seabed (at minimal depths typically less than 50 m), and floating wind turbines which offer the advantage of being constructed on land and implanted in areas where the seabed depth typically exceeds 50 m.

Floating wind turbines which are the subject matter of the present invention comprise a turbine generally formed by a motor having several rotating blades with horizontal axis and an electric generator coupled to the motor, the motor and the generator being fixed to an upper end of a vertical mast (or pylon). The lower end of the mast is per se mounted on a floating support structure.

There are four main families of floating support structure for offshore wind turbine: semi-submersible floats, immersed floats with tensioned cables (or ‘TLP’ platforms for ‘Tension-Leg Platform’), floats of ‘SPAR’ type (for ‘Single Point Anchor Reservoir’), semi-submersible floats of ‘barge’ type and floats with a pendulum counterweight.

Semi-submersible floats constitute the model of float most widely used currently. This involves a foundation made of steel or concrete which is generally in the form of a tripod having three (or four) cylindrical columns joined together by metal structures. The stability of the structure is ensured by a ballast system which allows immersion of part of the foundation. This structure is characterised by its large size and its shallow draught. Reference could be made to the publication WO 2019/106283 which describes a semi-submersible float structure and a process for installation of a wind turbine fitted with such a float structure.

Platforms of ‘TLP’ type are floats which have the particular feature of being mostly immersed, the platform being connected to the seabed by tension cables which prevent the float from rising by exerting a downward force.

The float of ‘SPAR’ type is characterised by its cylindrical shape fitting in the extension of the mast of the wind turbine. Its stability is conferred by heavy ballast which lowers the centre of gravity of the unit and which is equipped with catenary anchors for fastening the wind turbine by hooking it to the seabed. Reference can be made to publications WO 2005/021961, WO 2006/121337 and WO 2006/132539 which describe embodiments of a ‘SPAR’ platform, its anchorage and its installation process at sea.

Finally, semi-submersible floats of ‘barge’ type are in the form of a more compact foundation which is comparable to a rectangular barge pierced through its centre and constituted mainly by concrete or steel.

Most floating support structures were not designed to fit into the scope of large-scale industrialisation. In fact, these floats generally comprise a large number of elements to be assembled, requiring time and ground space.

### DISCLOSURE OF THE INVENTION

The aim of the invention is to propose a floating support structure (of ‘SPAR’ type, semi-submersible or ‘TLP’ type) for offshore wind turbine which simplifies its assembly, accelerates assembly time and minimises land space required.

In keeping with the invention, this aim is achieved by a floating support structure with multiple central columns for offshore wind turbine, comprising:
at least two identical and independent tubular central columns which are assembled together around an axis of a mast of the wind turbine so as to form a floating support pylon fitting in the vertical extension of the mast of the wind turbine;
a lower connector centred on the axis of the mast of the wind turbine and intended to ensure that the forces of the central columns are held and taken up at their respective lower ends; and
an upper connector centred on the axis of the mast of the wind turbine and in an upper part comprising reception means of the mast of the wind turbine and, in a lower part at least two upper receptacles to receive an upper end of the central columns.

The invention is remarkable in that it is based on a modular approach to construct the floating support structure. In particular, from upper and lower connectors the invention provides for the floating support pylon to be formed by using a plurality of identical and independent central columns which are assembled because of these connectors. The number of central columns could be 2, 3, 4, 5, 6, etc. and therefore varies the design of the floating support structure as a function of the conditions of the implantation site of the structure.

The fact that the central columns are all identical considerably simplifies the assembling of the floating support structure. In fact, these central columns, though also the upper and lower connectors, can be prefabricated in series using the same model and assembled rapidly on site. This results in simplified assembly and a time gain.

The floating support pylon can be devoid of a crosspiece so as to form a float of SPAR type.

Alternatively, each central column can be connected to at least one tubular crosspiece an end of which opposite the central column constitutes a flotation node spaced radially from the floating support pylon so as to form a float of semi-submersible type.

In a variant, each central column is connected on the one hand in the region of its lower end to at least one radial crosspiece, and on the other hand above its lower end to at least one diagonal crosspiece, the radial crosspiece and the diagonal crosspiece being connected together in the region of the flotation node so as to form a floating unit assembly of triangular shape.

In another variant, each central column is connected on the one hand in the region of its lower end to at least one first radial crosspiece, and on the other hand above its lower end to at least one second radial crosspiece, the radial crosspieces being connected together in the region of the flotation node so as to form a floating unit assembly of rectangular shape.

Advantageously, each floating unit assembly comprises at least one flotation module positioned in the region of its flotation node.

Each of these flotation modules can comprise a central rod extending parallel to the axis of the mast of the wind turbine and on which are fitted at least one steel ring and/or at least one ring made of non-metallic material.

The axis of the mast of the wind turbine can be aligned on a centre of symmetry of the float. Alternatively, the axis of the mast can be offset relative to a centre of symmetry of the float.

Preferably, the respective flotation nodes of the floating unit assemblies are connected to each other by at least one cable, the flotation nodes comprising tensioning devices of the cable.

The structure can also comprise at least one flotation element positioned around the cable.

Preferably, each floating unit assembly comprises a network of ballast pipes housed inside at least one of the crosspieces and of the central column.

The floating support pylon and/or at least one of the radial crosspieces can comprise at least one central flotation unit.

In a variant, the lower connector is an independent piece of the central columns and comprises at least two lower receptacles to each receive a lower end of the central columns.

In another variant, the lower connector is a cable clamp which clamps the respective lower ends of the central columns.

Another aim of the invention is an assembly process of a floating support structure such as defined previously, comprising a dry assembly step of the lower end of each central column on the lower connector, followed by a dry assembly step of the upper connector on the upper end of each central column.

Yet another aim of the invention is an assembly process of a floating support structure such as defined previously, comprising successively:
an assembly step of the floating unit elements on the lower connector by lifting each unit element and by pivoting it to have the flotation node rest on a support previously positioned on land to ensure proper lateral positioning of the floating unit element;
an assembly step of the upper connector on the upper end of the central column of each floating unit element; and
a connection step of the central columns of the floating unit elements to the upper and lower connectors by welding, by adhesion or by mechanical assembly.

The assembly steps can be taken on a submersible platform for launching the floating support structure in a calm area protected from the swell.

In this case, the submersible platform is advantageously equipped with a lifting gantry for assembling the mast of the wind turbine on the upper part of the upper connector of the floating support structure.

### BRIEF DESCRIPTION OF THE DRAWINGS

FIG. 1 is a perspective view of a floating support structure of semi-submersible type having four floating unit assemblies according to a first embodiment of the invention.

FIG. 2 is a side view of the floating support structure of FIG. 1.

FIG. 3 is an exploded view of the floating support structure of FIGS. 1 and 2.

FIG. 4A is a perspective view of a floating support structure of SPAR type according to a second embodiment of the invention.

FIG. 4B is an exploded view of a variant of the floating support structure of SPAR type according to this second embodiment.

FIG. 5 is a perspective view of a floating support structure of semi-submersible type having three floating unit assemblies according to a third embodiment of the invention.

FIG. 6 is a perspective view of a floating support structure of semi-submersible type having five floating unit assemblies according to a fourth embodiment of the invention.

FIG. 7 is a perspective view of a floating support structure of semi-submersible type having six floating unit assemblies according to a fifth embodiment of the invention.

FIG. 8 is a perspective view of a floating support structure according to a variant embodiment of the first embodiment of the invention.

FIG. 9 is a perspective view of the floating support structure according to another variant embodiment of the first embodiment of the invention.

FIGS. 10 to 17 are views showing an example of the different steps of an assembly process according to the invention of a floating support structure of FIG. 1.

FIG. 18 shows an example of maintenance on an offshore wind turbine mounted on the floating support structure of FIG. 1.

FIG. 19 is a perspective view of the floating support structure according to yet another variant embodiment of the first embodiment of the invention with a central flotation unit between the central columns.

FIG. 20 is a perspective view of a variant embodiment of the floating support structure according to the third embodiment of the invention.

FIG. 21 is a perspective view of a floating support structure of semi-submersible type and offset to two floating unit assemblies according to a sixth embodiment of the invention.

FIG. 22A shows a variant embodiment of the floating support structure according to the third embodiment.

FIG. 22B shows another variant embodiment of the floating support structure according to the third embodiment.

FIG. 23 shows an embodiment of a ballast pipe network within floating support structure according to the invention.

### DESCRIPTION OF EMBODIMENTS

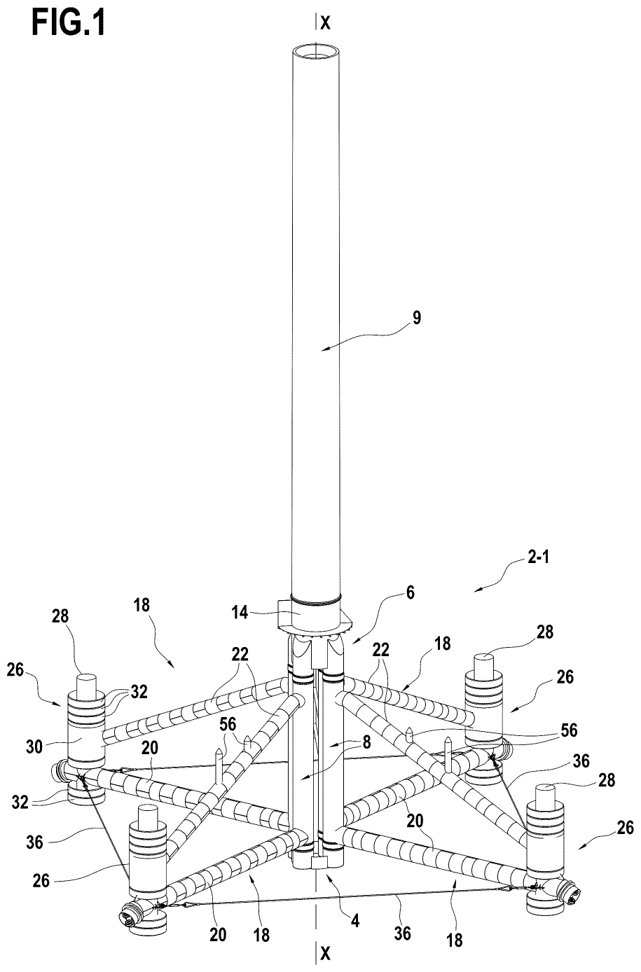

FIGS. 1 to 3 illustrate a floating support structure 2-1 of semi-submersible type according to a first embodiment of the invention and intended to receive an offshore wind turbine mast (not shown).

According to the invention, the floating support structure 2-1 comprises an assembly between a lower connector 4, an upper connector 6, and a plurality (that is, at least two, and as many as four on the first embodiment of FIGS. 1 to 3) of tubular central columns 8 which are all identical and independent of each other so as to form a pylon fitting in the vertical extension of the mast 9 of the wind turbine.

The central columns 8 generally have a diameter of between 2 and 4 meters. They can be reinforced or not on the inside. They are typically made by way of different assembly technologies and are easy to produce without substantial investment.

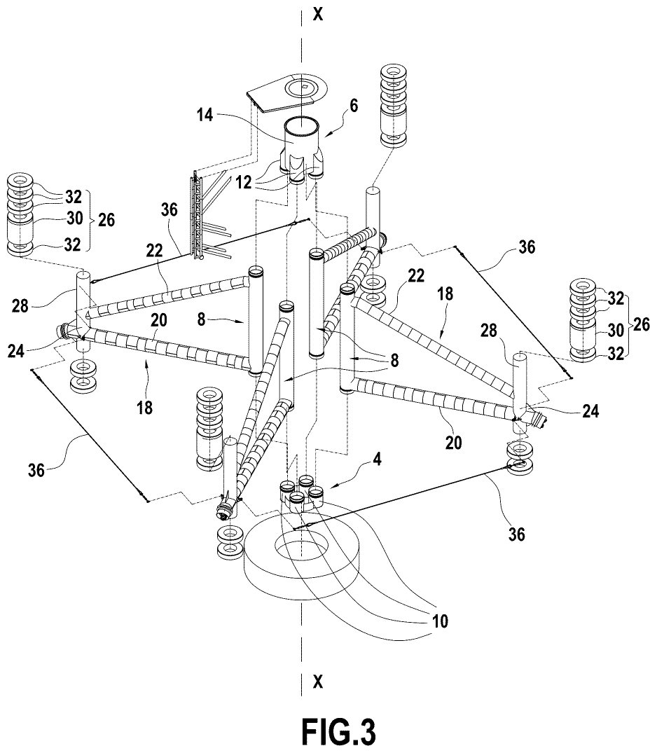

As shown in FIG. 3, in this embodiment the lower connector 4 is an independent piece of the central columns which is centred on a vertical axis X-X of the mast of the wind turbine and which comprises at least two (four in this embodiment) lower receptacles 10 evenly distributed around the vertical axis X-X, open towards the top and each intended to receive the lower end of a central column 8 by nesting of complementary shapes.

Similarly, the upper connector 6 is an independent piece of the central columns which is centred on a vertical axis X-X of the mast 9 of the wind turbine and which in a lower part comprises at least two (four in this embodiment) upper receptacles 12 evenly distributed around the vertical axis X-X, open towards the bottom and each intended to receive the upper end of a central column 8 by nesting of complementary shapes.

In an upper part the upper connector 6 also comprises reception means of the mast 9 of the wind turbine. Typically, these reception means are in the form of a ring 14 inside which is fitted the lower end of the mast of the wind turbine prior to be fastened (by welding for example).

Of course, it is possible to envisage other reception means of the mast of the wind turbine. Similarly, it is possible to envisage that the upper connector creates one and the same piece having a part at least of the mast of the wind turbine.

As for the central columns 8, they are all identical, independent of each other, and each is in the form of a cylinder which extends vertically and the lower end of which is nested then assembled inside one of the receptacles 10 of the lower connector 4, and the upper end is nested then assembled inside one of the receptacles 12 of the upper connector 6.

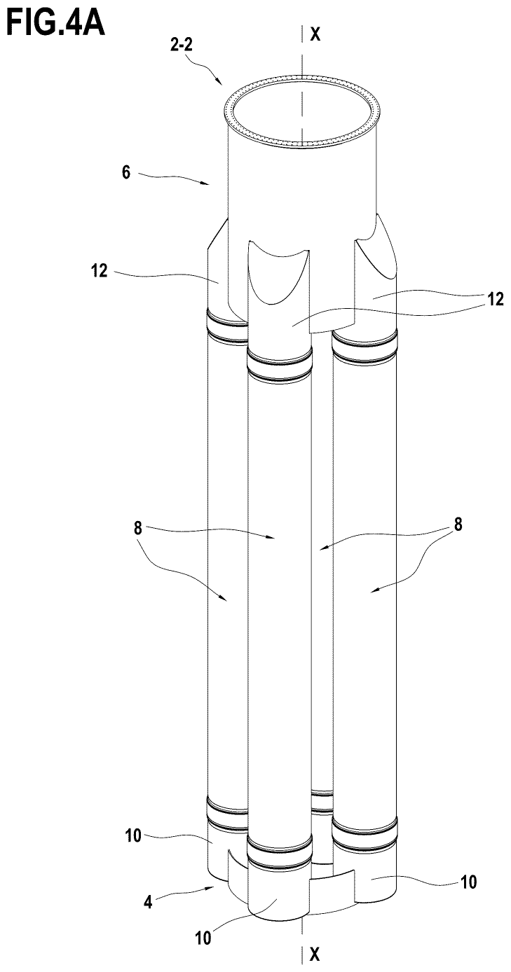

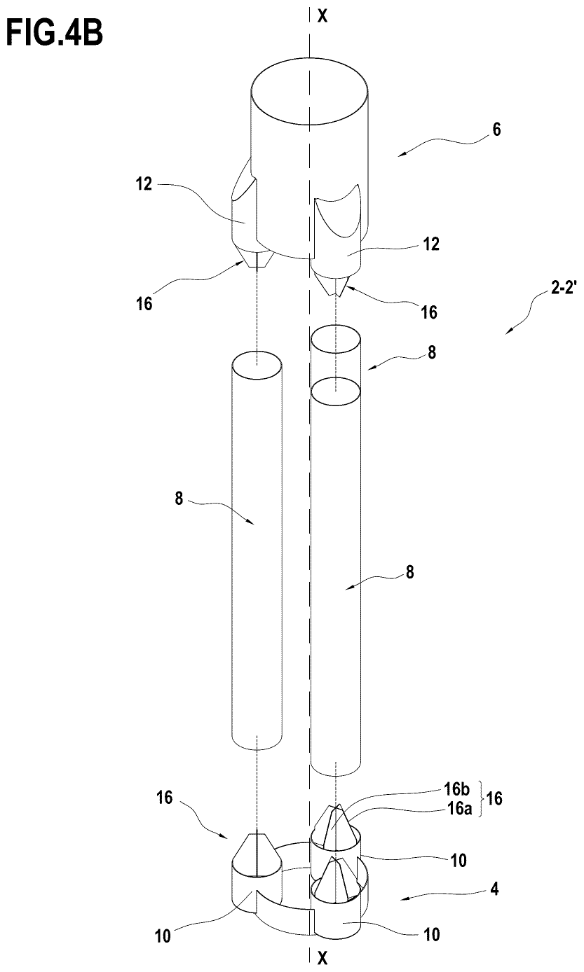

Preferably, as shown in FIG. 4B, the receptacles 10 of the lower connector and/or the receptacles 12 of the upper connector each comprise a centring guide 16 intended to make assembly of a corresponding end of a central column easier.

For example, in the embodiment of FIG. 4B, these centring guides 16 are in the form of two plates 16a, 16b positioned in a cross and bevelled in their respective terminal part to form a point. Of course, the centring guides can take other forms.

Once fitted inside the receptacles 10, 12 of the upper and lower connectors, the central columns 8 are fastened to the connectors by welding, by adhesion or by mechanical assembly.

The first embodiment of the invention illustrated by FIGS. 1 to 3 relates to a float of ‘semi-submersible’ type having four floating unit assemblies.

‘Floating unit assembly’ means that for each central column there is at least one radial tubular crosspiece and at least one diagonal tubular crosspiece provided which are connected, on the one hand to the central column, and on the other hand to a flotation node spaced radially from the floating support pylon.

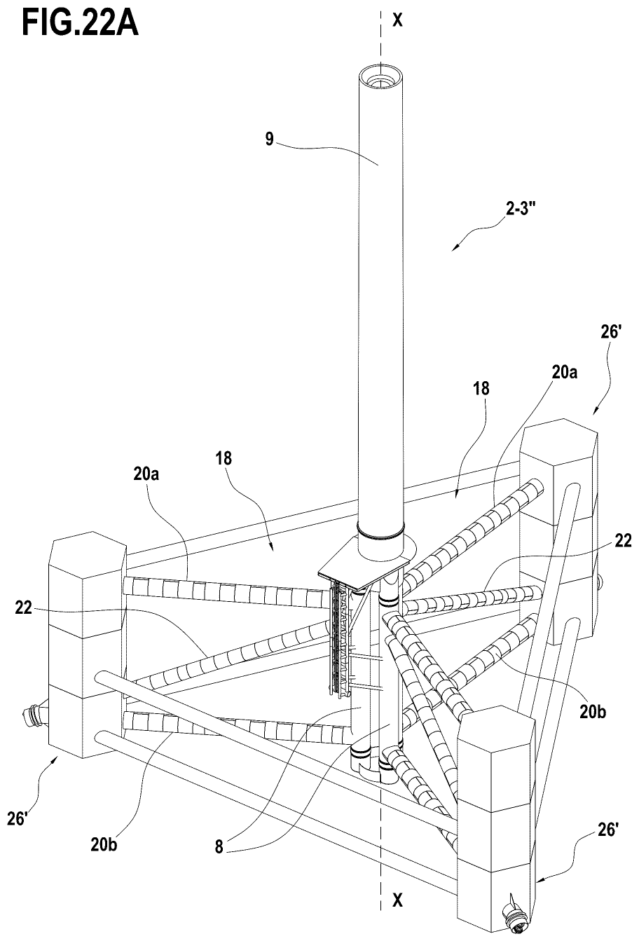

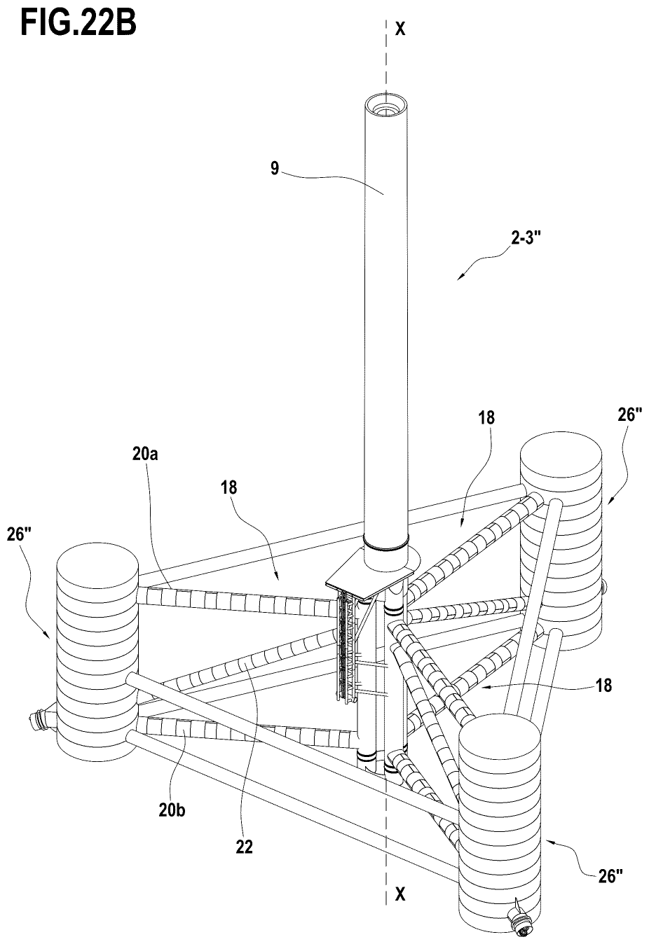

In the different embodiments described hereinbelow (with the exception of the one described in relation to FIGS. 4A, 4B, 22A and 22B), the floating unit assemblies have a triangular shape.

More precisely for these embodiments, for each central column 8 a radial tubular crosspiece 20 is connected to a lower end of the column by forming an angle between 75° and 90° with the latter, and a diagonal tubular crosspiece 22 is connected on the one hand to the column above the lower end of the latter and on the other hand to a free end of the radial crosspiece by forming with the latter a flotation node 24 spaced radially from the vertical axis X-X so as to form a floating unit assembly 18 having a triangular shape.

These floating unit elements 18 of triangular shape are preferably all identical to each other, which on the one hand makes them easier to produce and on the other hand make them easier to assemble on the upper and lower connectors.

In this first embodiment, the floating support structure 2-1 has four floating unit assemblies 18 of identical triangular shape which are evenly spaced from each other (that is, by the same angle of 90°).

Of course, the floating unit assemblies can have forms other than a triangular shape as a function of the number and arrangement of the radial and diagonal crosspieces. Similarly, they are not necessarily all identical to each other.

Also, each floating unit assembly 18 comprises a flotation module 26 which is positioned in the region of its flotation node 24, that is, at the free end of the radial 20 and diagonal crosspieces 22 opposite the vertical axis X-X of the mast.

Each flotation module 26 comprises a central rod 28 which extends parallel to the vertical axis X-X of the mast and on which at least one steel ring 30 forming a ballast tank and/or at least one ring made of non-metallic material 32 are fitted.

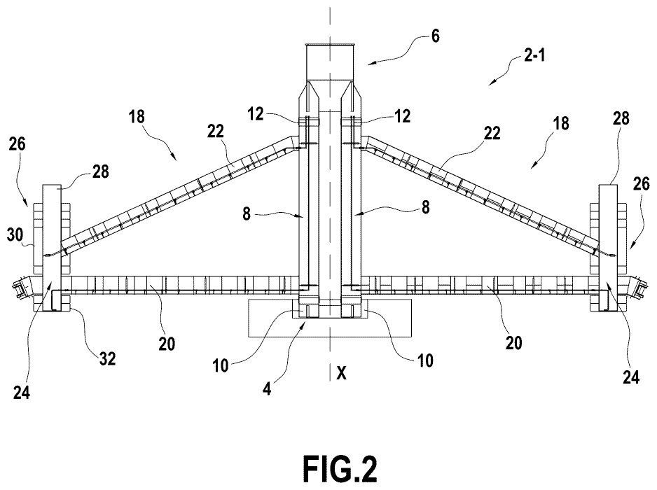

In the embodiment of FIGS. 1 and 2, each flotation module 26 therefore comprises a steel ring 30 surmounted by three rings of non-metallic material 32, two other rings of non-metallic material 32 being mounted under the steel ring 30.

By way of advantage, the non-metallic rings 32 are standardised and all identical to each other (in terms of dimensions and material), which helps adjust their number to each flotation node 24 as a function of the conditions of implantation of the wind turbine.

These non-metallic rings 32 are made of non-metallic materials, either solid or of syntactic foam to carry out a flotation role. The non-metallic materials can be thermosetting, thermoplastic or elastomers. These non-metallic rings are kept on the central rod 28 by any means (for example by circlips).

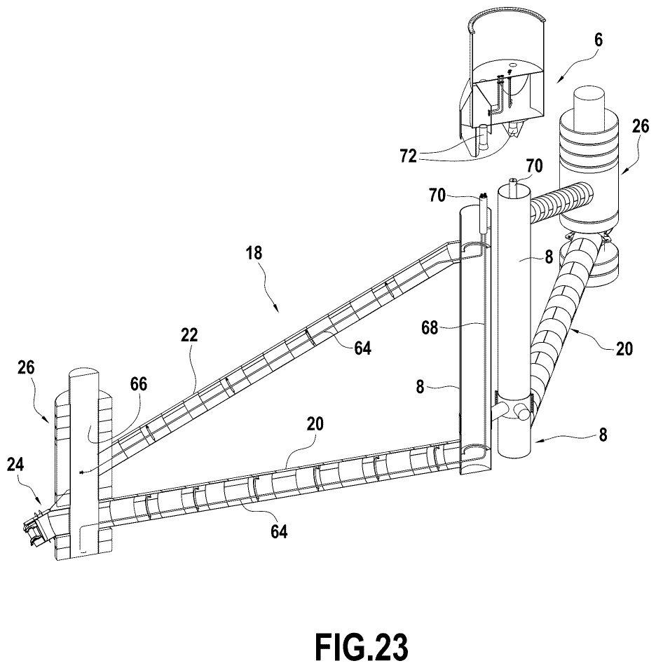

In addition, the steel rings 30 forming ballast tanks are connected to a ballast pipe network (described in relation to FIG. 23) which is housed inside at least one of the crosspieces 20, 22 and the central column to terminate in the region of a control zone (not shown in the figures) located above the upper connector 6.

The respective flotation nodes 24 of the floating unit assemblies 18 are connected to each other by at least one cable 36, at least some of the flotation nodes being equipped with a device for tensioning the cable. The cable or cables 36 are accordingly prestressed and effectively reduce the overall weight of the floating support structure and shorten the assembly time of the latter.

As shown in FIG. 1 relative to the first embodiment, it can be a plurality of metal cables 36 connecting the flotation nodes of the floating unit assemblies 18 in pairs.

In this case, tensioning of the cables 36 can be ensured by a screw-nut system, or a hydraulic jack (working in traction) to pull the end of the cable towards one of the flotation nodes, while the other end of the cable is connected to the adjacent flotation node. In this configuration, there are as many tensioning devices of the cables as there are floating unit elements 18. These tensioning devices can be removable in the case of hydraulic jacks.

In a variant having several cables (not shown), a single device for tensioning of the cable can be provided. As the latter is tensed, the other cables are also tensed because in this variant the floating unit elements have a possible degree of rotation around the vertical axis X-X in the region of their anchorage in the upper and lower connectors.

In a variant embodiment not shown, this can be the same and only cable or metal chain which connects all the flotation nodes of the floating unit assemblies. In this variant, the single cable passes over grooves made to each flotation node, these grooves being fitted with blockers (cable clamps) for fixing the position of the cable once the tension is created. In this way, the trajectory of the cable corresponds to the circumference of the floating support structure defined by the floating unit assemblies 18. The tension of the cable or of the chain is created by a device such as a jack or a screw-nut system fixed to the two ends of the cable (or of the chain).

Finally, a possible alternative to the cables is to resort to horizontal steel spacers joining together the flotation nodes of the floating unit elements. Rapid mechanical connectors then ensure the linking between the spacers and the flotation nodes to reduce installation time to a maximum.

FIG. 4A and FIG. 4B illustrate two variants of a floating support structure 2-2, 2-2′ according to a second embodiment of the invention, respectively in perspective and in an exploded view.

The floating support structures 2-2, 2-2′ according to the second embodiment of the invention form floats of ‘SPAR’ type (for ‘Single Point Anchor Reservoir’), that is, floats of cylindrical shape nesting in the extension of the mast of the wind turbine.

More precisely, the floating support structure 2-2 according to the variant of FIG. 4A comprises four tubular central columns 8 which are all identical to each other and independent of each other so as to form a pylon fitting in the extension vertical of the mast of the wind turbine.

Similarly, the floating support structure 2-2′ according to the variant of FIG. 4B comprises three tubular central columns 8 which are all identical to each other so as to form a pylon.

Also, contrary to the first embodiment, the central columns 8 forming the pylon of these two floating support structures 2-2, 2-2′ are all devoid of a crosspiece (both radial and diagonal).

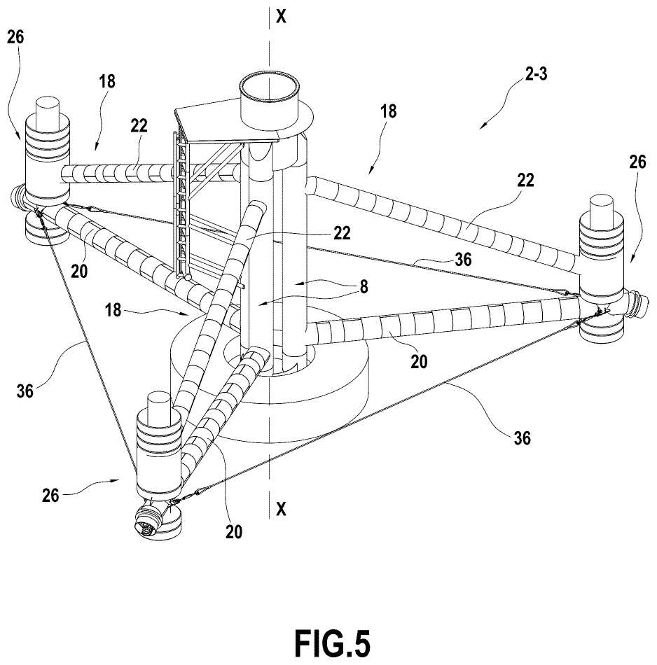

FIG. 5 is a perspective view of a floating support structure 2-3 according to a third embodiment of the invention.

In this embodiment, the floating support structure 2-3 forms a semi-submersible float having three floating unit assemblies 18 which are spaced angularly from each other by the same angle of 120°. In this configuration, the cables 36 form a triangle.

The other characteristics of this floating support structure are similar to those described in connection with the first embodiment.

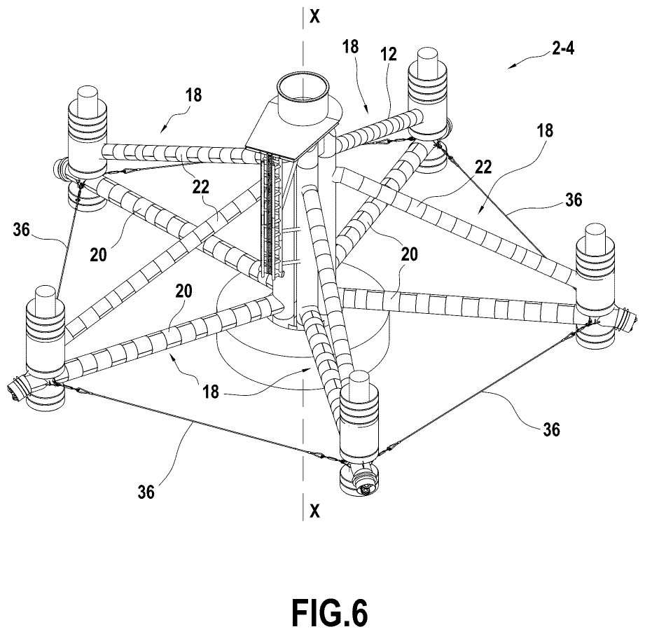

FIG. 6 is a perspective view of a floating support structure 2-4 according to a fourth embodiment of the invention.

In this embodiment, the floating support structure 2-4 forms a semi-submersible float having five floating unit assemblies 18 which are spaced angularly from each other by the same angle of 72°. In this configuration, the cables 36 form a pentagon.

The other characteristics of this floating support structure are similar to those described in connection with the first embodiment.

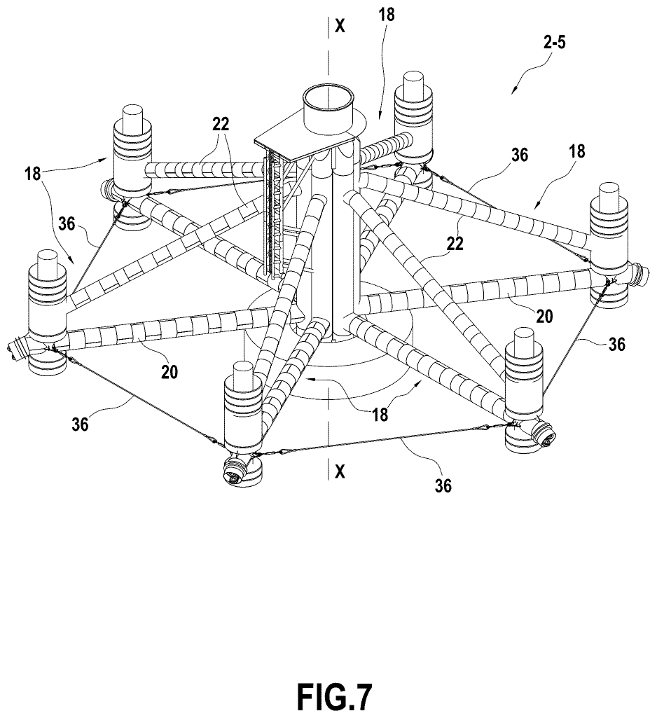

FIG. 7 is a perspective view of a floating support structure 2-5 according to a fifth embodiment of the invention.

In this embodiment, the floating support structure 2-5 forms a semi-submersible float having six floating unit assemblies 18 which are spaced angularly from each other by the same angle of 60°. In this configuration, the cables 36 form a hexagon.

The other characteristics of this floating support structure are similar to those described in connection with the first embodiment.

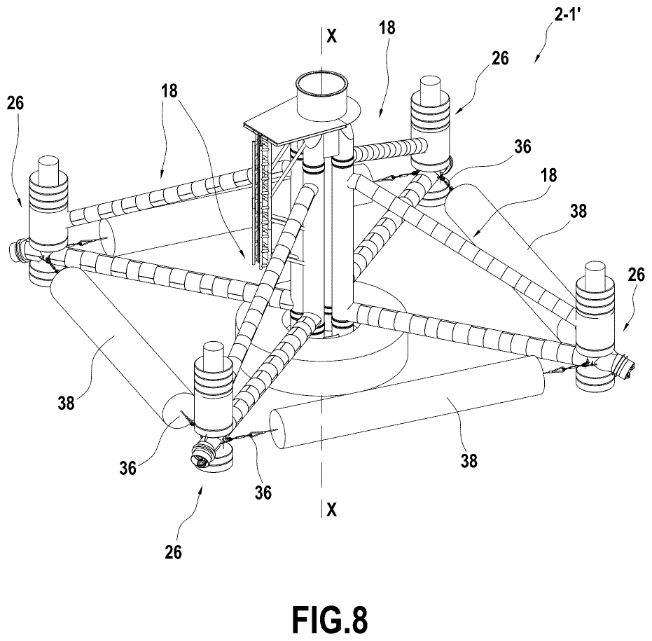

FIG. 8 is a perspective view of a floating support structure 2-1′ according to a variant embodiment of the first embodiment of the invention, that is, a floating support structure forming a semi-submersible float having four floating unit assemblies 18 which are spaced angularly from each other by the same angle of 90°.

The particular feature of this variant embodiment is that flotation elements 38 are positioned around each cable 36. For example, these flotation elements 38 are in the form of foam cylinders mounted around the cables.

These flotation elements 38 form a complement to the flotation modules 26 positioned in the region of the flotation nodes of the floating unit assemblies 18.

The other characteristics of this floating support structure are similar to those described in connection with the first embodiment.

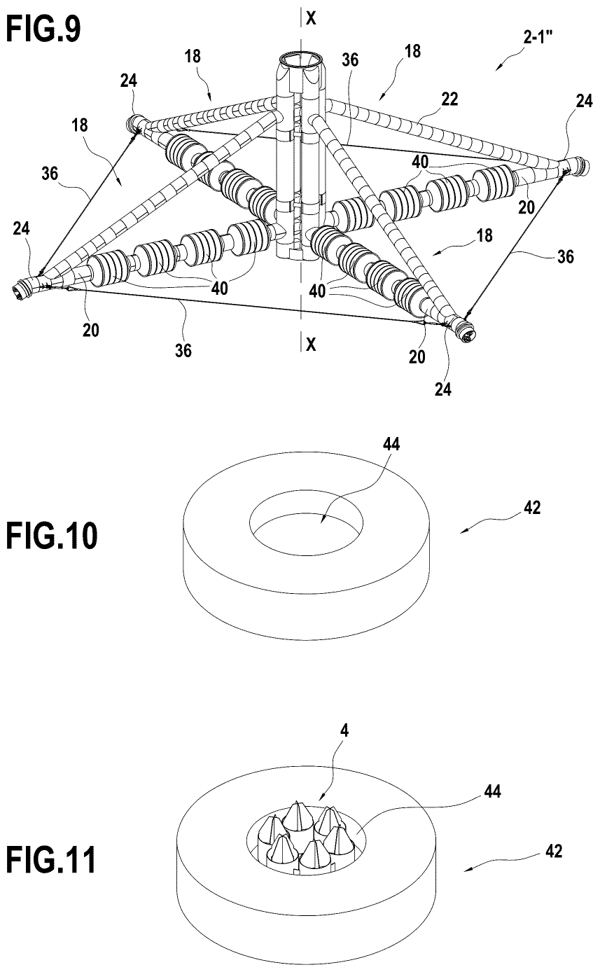

FIG. 9 is a perspective view of a floating support structure 2-1″ according to another variant embodiment of the first embodiment of the invention, that is, a floating support structure forming a semi-submersible float having four floating unit assemblies 18 which are spaced angularly from each other by the same angle of 90°.

The particular feature of this variant embodiment is that flotation units 40 are positioned around the radial crosspieces 20 of each floating unit assembly 18. For example, these flotation units 40 are in the form of foam cylinders mounted around the radial crosspieces.

Here, these flotation units 40 act as replacement for the flotation modules positioned in the region of the flotation nodes 24 of the floating unit assemblies 18.

The other characteristics of this floating support structure are similar to those described in connection with the first embodiment.

In relation to FIGS. 10 to 17, these describe an example of assembly and installation of a floating support structure according to the invention, in particular the floating support structure 2-5 according to the fifth embodiment of the invention.

Of course, the assembly process applied to the other embodiments of the invention results obviously from that described hereinbelow.

The assembly can be performed dockside or on an assembly platform at sea (of catamaran type) which can be submersible. Using a submersible catamaran gives greater autonomy, is not dependent on the installation site and above all the availability of lifting means on the site.

Prior to launch of the assembly, the upper and lower connectors, as well as the floating unit assemblies can be produced in series.

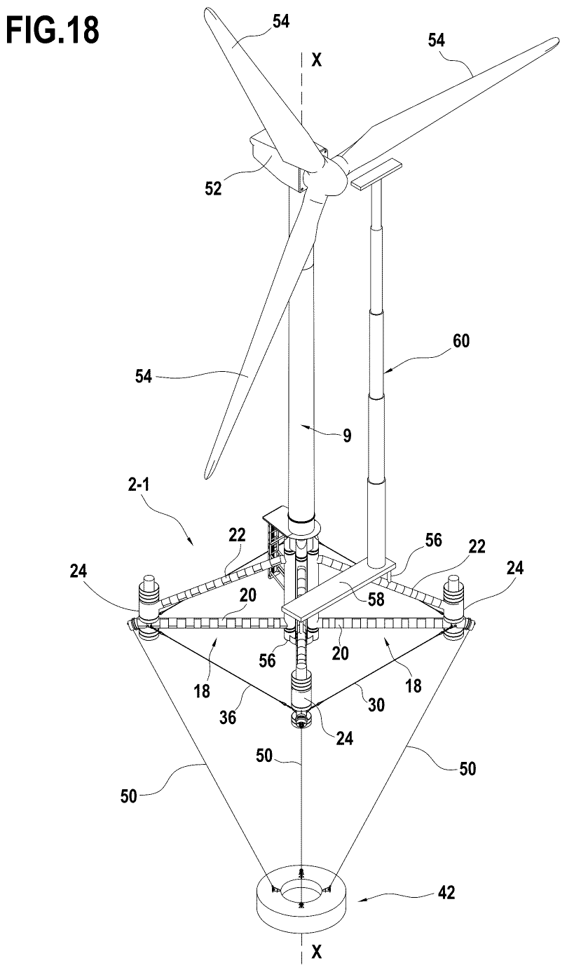

In a first step, a counterweight 42 of cylindrical shape is placed on the ground on the assembly site, this counterweight being intended to be secured by ties 50 to the flotation nodes 24 of the floating unit assemblies 18 to ensure gravity anchoring of the floating support structure (see the positioning illustrated in FIG. 18).

In the embodiment shown in FIG. 10, this counterweight 42 exhibits a central recess 44 intended to take up the lower connector of the floating support structure.

In the following step illustrated by FIG. 11, the lower connector 4 of the floating support structure is shifted (for example by means of a crane or a lifting gantry) to be positioned in the recess 44 of the counterweight 40. In the absence of such a recess, the lower connector is deposited directly on the counterweight.

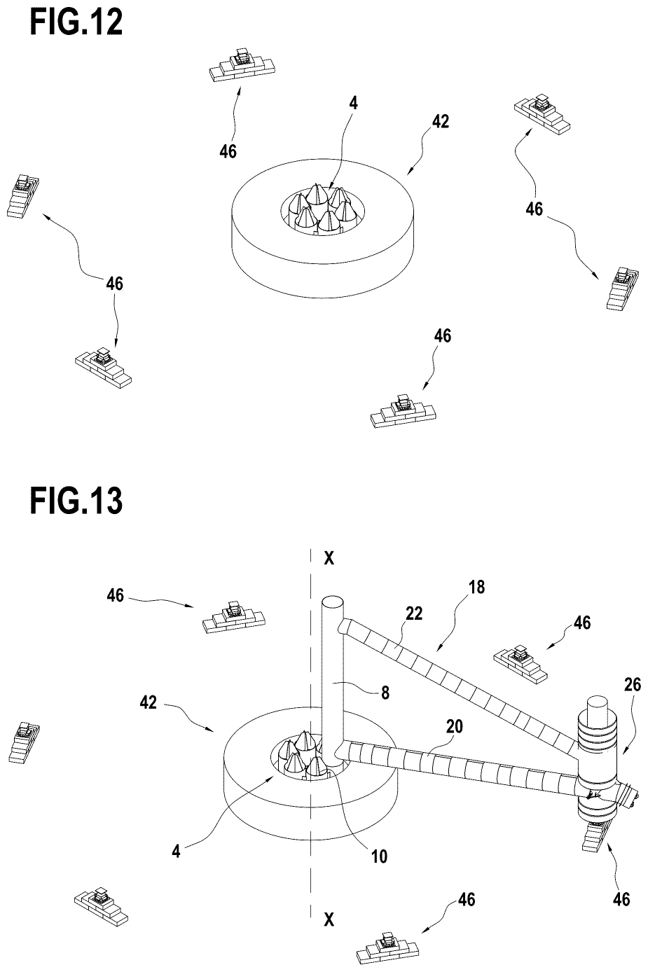

During the following step (FIG. 12), positioning supports 46 are advantageously placed on the assembly site around the counterweight 42 at precise locations where the flotation modules of the floating unit assemblies are to rest.

These positioning supports 46 will enable rapid and precise positioning of the floating unit elements as well as perfect adjustment of the verticality of the central columns during placing of the upper connector. Of course, they can be reuseable.

As shown in FIG. 13, the floating unit elements 18 are assembled in succession on the lower connector 4. For this purpose, each floating unit element 18 is lifted (by means of the crane or the lifting gantry) to introduce the lower end of its central column 8 vertically into one of the receptacles 10 of the lower connector. The floating unit element is also pivoted around its central column to have its flotation module 26 rest on one of the positioning supports 46.

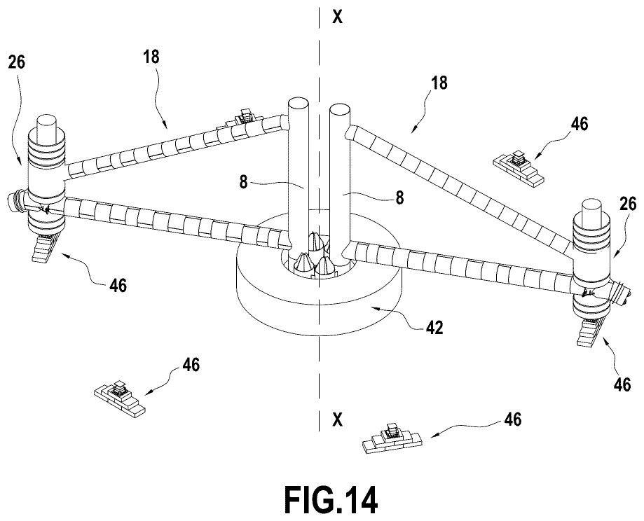

FIG. 14 shows the progress of the process with the assembly of a second floating unit element 18 on the lower connector 4.

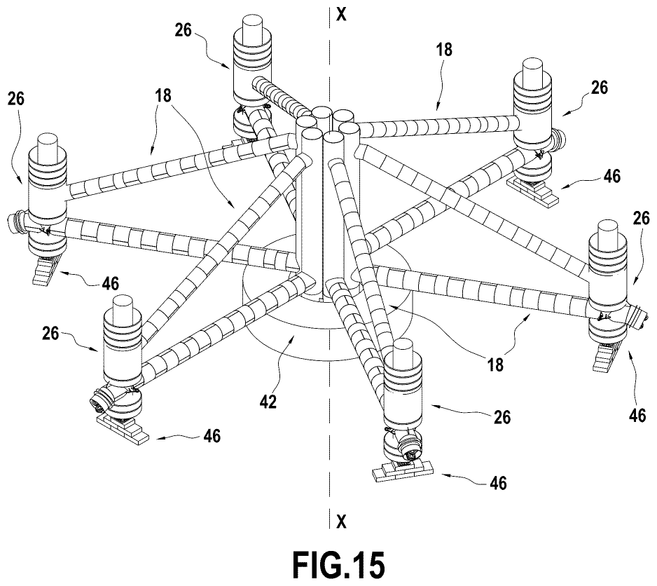

FIG. 15 shows the structure once all the floating unit elements 18 are assembled on the lower connector 4.

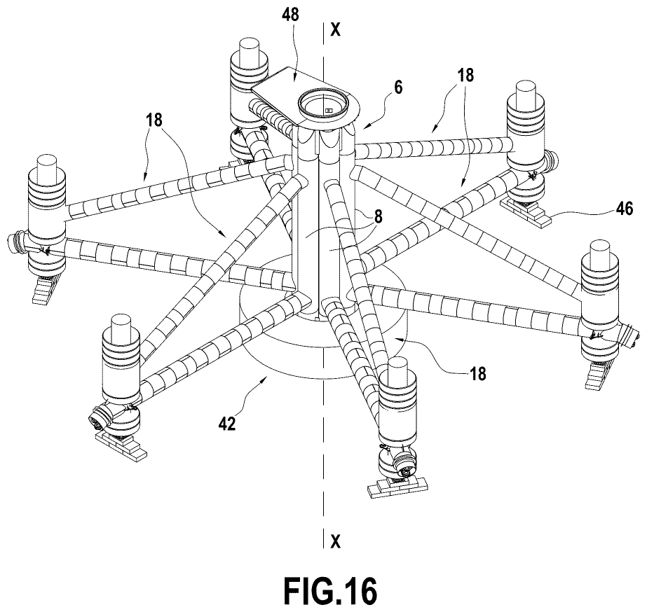

Once all the floating unit elements 18 are assembled and then fastened (by welding, by adhesion or by mechanical assembly) on the lower connector 4, the following step shown in FIG. 16 consists of assembling (by means of the crane or the assembly gantry) the upper connector 6 on the upper end of the central columns, then ensuring fastening of these pieces together (by welding, by adhesion or by mechanical assembly).

A control platform 48 can then be mounted around the upper end of the upper connector 6.

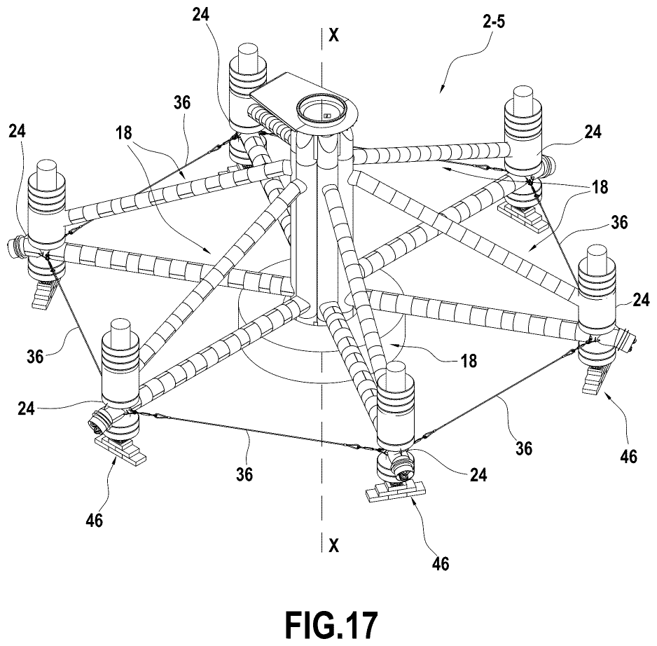

In a final assembly step of the floating support structure 2-5 (FIG. 17), the cables 36 are fixed to the respective flotation nodes 24 of the floating unit assemblies 18 and then tensed. The mast and the turbine of the wind turbine can then be installed by means of the crane or the lifting gantry.

As shown in FIG. 18, maintenance of the offshore wind turbine mounted on a floating support structure according to the invention (here the structure 2-1 having four floating unit assemblies of FIG. 1) is possible especially to enable replacement of the components of the turbine 52 or the blades 54.

For this purpose, the diagonal crosspieces 22 of at least some of the floating unit assemblies 18 of the floating support structure 2-1 are equipped with spindles 56 (see also FIG. 1) to enable the installation of a temporary platform 58 for installing a telescopic structure 60.

It is clear that the spindles 56 can also take up other maintenance structures associated with options of climbing cranes.

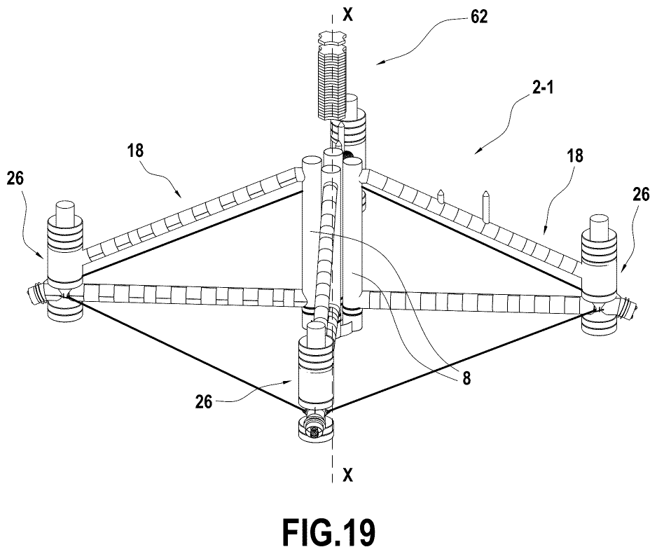

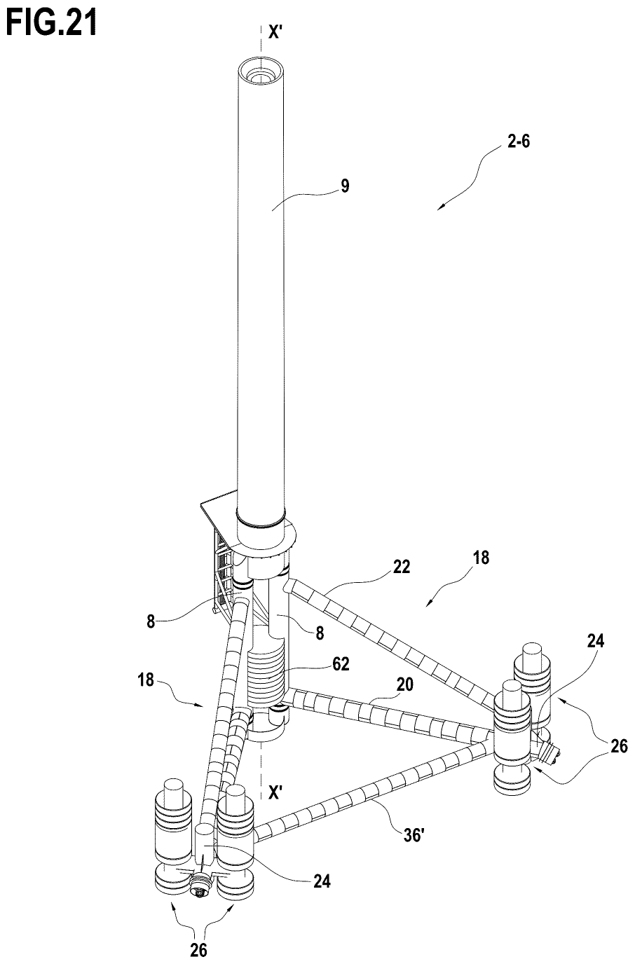

Irrespective of the embodiment of the invention, it is clear that during assembly of the floating support structure it is possible to insert at least one central flotation unit 62 between the central columns 8 forming the pylon (see FIG. 19 with a floating support structure 2-1 having four floating unit assemblies 18 and FIG. 21 with a floating support structure 2-6 having two floating unit assemblies). This central flotation unit 62 boosts flotation of the floating support structure.

In this way, in the example illustrated in FIG. 19, this central flotation unit 62 (for example a foam cylinder) is inserted vertically along the axis X-X between the central columns prior to the step for placing of the upper connector on the upper end of the central columns.

In an alternative not shown in the figures, such a central flotation unit can be pre-installed on the first central column which is assembled during installation of the floating support structure.

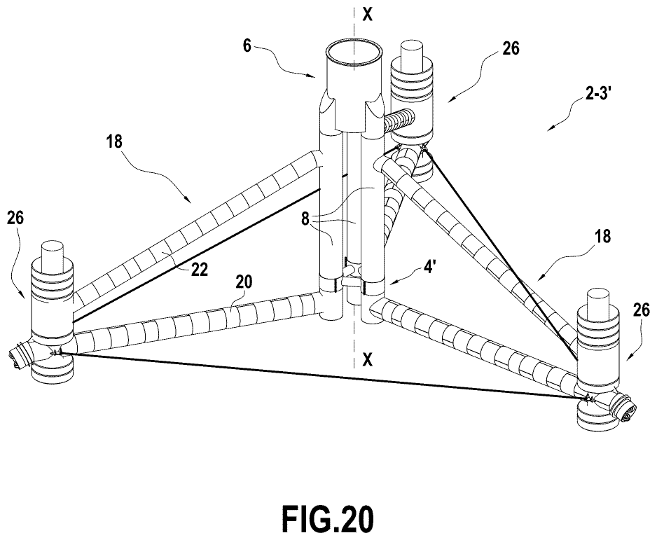

FIG. 20 is a perspective view of a variant embodiment of the floating support structure 2-3′ according to the third embodiment of the invention.

This variant embodiment differs from that described in connection with FIG. 5 in that the lower connector of the structure comprises no lower receptacles to receive the lower ends of columns. Here, this is a simple cable clamp 4′ for clamping the respective lower ends of the central columns.

In this variant embodiment, for easier assembly of the central columns of the floating support structure 2-3′ a lower connector of the type of that described in connection with FIG. 5 can be installed temporarily on the ground.

All the embodiments of the floating support structure according to the invention which have been described up to this point relate to structures whereof the axis X-X of the mast of the wind turbine is aligned on a centre of symmetry of the float (the floating support pylon is aligned on the centre of symmetry of the structure).

By way of contrast, FIG. 21 is a perspective view of a floating support structure of semi-submersible type according to a sixth embodiment of the invention, which is offset.

In this sixth embodiment, the floating support structure 2-6 comprises only two floating unit assemblies 18, which together form an angle which differs by 180°. Also, the axis X′-X′ of the mast 9 of the wind turbine is offset relative to the centre of symmetry of the structure.

Also, in this sixth embodiment, each of the two floating unit assemblies 18 comprises two flotation modules 26 which are positioned in the region of their respective flotation node 24. Of course, the presence of two flotation modules per floating unit assembly can apply to the floating support structures of other embodiments.

Still in this sixth embodiment, the cable connecting the respective flotation nodes 24 of the two floating unit assemblies 18 is replaced by a bracing element 36′.

Also, this sixth embodiment provides for positioning a central flotation unit 62 between the central columns 8 forming the pylon.

FIG. 22A and FIG. 22B show two variant embodiments of the floating support structure 2-3″ of semi-submersible type having three floating unit assemblies of rectangular shape according to the third embodiment.

In these two variant embodiments, each floating unit assembly 18′ exhibits a rectangular shape with a central column 8, as well as two radial crosspieces 20a, 20b (specifically a high radial crosspiece 20a and a low radial crosspiece 20b spaced apart according to the axis X-X of the mast 9) and a diagonal crosspiece 22.

Also, in the variant embodiment of FIG. 22A the flotation modules 26′ are in the form of vertical columns of polygonal cross-section (hexagonal here) which can be made by assembly of flat panels.

In the variant embodiment of FIG. 22B, the flotation modules 26″ are in the form of vertical columns of cylindrical shape.

FIG. 23 shows an embodiment of a ballast pipe network within a floating support structure according to the invention (shown partially in figure), and more particularly within a floating unit assembly 18 of triangular shape.

This ballast pipe network comprises pipes 64 which are housed inside the radial 20 and diagonal 22 crosspieces of the floating unit assembly. These pipes 64 terminate in the region of the flotation modules inside ballast compartments 66 and open into the same central conduit 68 housed inside the central column 8 of the floating unit assembly.

In the region of its upper end, the central conduit 68 is advantageously fitted with a connection system 70 capable of cooperating with a complementary use system 72 housed in the upper connector 6 of the floating support structure. In other words, these systems 70, 72 form a unit of ‘plug and play’ type which makes assembly and starting up of the floating support structure easier.

1.-17. (canceled)

18. A floating support structure with multiple central columns for offshore wind turbine, comprising:
at least two identical and independent tubular central columns which are assembled together around an axis of a mast of the wind turbine so as to form a floating support pylon fitting in the vertical extension of the mast of the wind turbine;
a lower connector centered on the axis of the mast of the wind turbine and intended to ensure that the forces of the central columns are held and taken up at their respective lower ends; and
an upper connector centered on the axis of the mast of the wind turbine and comprising, in an upper part, reception means of the mast of the wind turbine and, in a lower part, at least two upper receptacles to receive an upper end of the central columns,
each central column being connected to at least one tubular crosspiece an end of which opposite the central column constitutes a flotation node spaced radially from the floating support pylon so as to form a float of semi-submersible type.

19. The structure according to claim 18, wherein each central column is connected on the one hand in the region of its lower end to at least one radial crosspiece, and on the other hand above its lower end to at least one diagonal crosspiece, the radial crosspiece and the diagonal crosspiece being joined together in the region of the flotation node so as to form a floating unit assembly of triangular shape.

20. The structure according to claim 18, wherein each central column is connected on the one hand in the region of its lower end to at least one first radial crosspiece, and on the other hand above its lower end to at least one second radial crosspiece, the radial crosspieces being connected together in the region of the flotation node so as to form a floating unit assembly of rectangular shape.

21. The structure according to claim 19, wherein each floating unit assembly comprises at least one flotation module positioned in the region of its flotation node.

22. The structure according to claim 21, wherein each flotation module comprises a central rod extending parallel to the axis of the mast of the wind turbine and on which are fitted at least one steel ring and/or at least one ring made of non-metallic material.

23. The structure according to claim 18, wherein the axis of the mast of the wind turbine is aligned on a center of symmetry of the float.

24. The structure according to claim 18, wherein the axis of the mast of the wind turbine is offset relative to a center of symmetry of the float.

25. The structure according to claim 18, the respective flotation nodes of the floating unit assemblies are connected to each other by at least one cable, the flotation nodes comprising tensioning devices of the cable.

26. The structure according to claim 25, also comprising at least one flotation element positioned around the cable.

27. The structure according to claim 18, wherein each floating unit assembly comprises a network of ballast pipes housed inside at least one of the crosspieces and of the central column.

28. The structure according to claim 18, wherein the floating support pylon and/or at least one of the radial crosspieces comprises at least one central flotation unit.

29. The structure according to claim 18, wherein the lower connector is an independent piece of the central columns and comprises at least two lower receptacles to each receive a lower end of the central columns.

30. The structure according to claim 18, wherein the lower connector is a cable clamp for clamping the respective lower ends of the central columns.

31. A process for assembling a floating support structure according to claim 18, comprising a dry assembly step of the lower end of each central column on the lower connector, followed by a dry assembly step of the upper connector on the upper end of each central column.

32. A process for assembling a floating support structure according to claim 19, comprising successively:
an assembly step of the floating unit elements on the lower connector by lifting each unit element and pivoting it to have the flotation node rest on a support previously positioned on land to ensure proper lateral positioning of the floating unit element;
an assembly step of the upper connector on the upper end of the central column of each floating unit element; and
a connection step of the central columns of floating unit elements to the upper and lower connectors by welding, by adhesion or by mechanical assembly.

33. The process according to claim 32, wherein the assembly steps are taken on a submersible platform enabling the floating support structure to be launched in a calm area protected from the swell.

34. The process according to claim 33, wherein the submersible platform is equipped with a lifting gantry for assembling the mast of the wind turbine on the upper part of the upper connector of the floating support structure.
